(19) United States
(12) Patent Application Publication
(10) Pub. No.: US 2009/0133894 A1
(43) Pub. Date: May 28, 2009

(54) ELECTRIC IMPACT TIGHTENING TOOL

(75) Inventor: Masaru Mizuhara, Osaka (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: YOKOTA INDUSTRIAL CO., LTD., Higashiosaka, shi, Osaka (JP)

(21) Appl. No.: 12/066,191

(22) PCT Filed: Sep. 6, 2006
(86) PCT No.: PCT/JP2006/317635

§ 371 Date: Nov. 25, 2008

(30) Foreign Application Priority Data
Sep. 7, 2005 (JP) 2005-258861
Jan. 31, 2006 (JP) 2005-022116

(51) Int. Cl. B25B 21/02; H02K 7/14; H02K 21/22

(52) U.S. Cl. 173/217; 310/50; 310/156.01

(57) ABSTRACT

An electric impact tightening tool in which the rotation of an output section of an electric motor is transmitted to an impact generation section (P) and impact force generated in the impact generation section (P) causes a main shaft (107) to produce strong torque, where the electric motor is an outer rotor electric motor (M). The outer rotor electric motor (M) has low-speed, high-torque characteristics. In the tool, the impact generation section (P) and a rotor flange (61) at the forward end of the motor (M) are adapted to rotate integrally. The electric impact tightening tool is small sized and lightweight, produces low reaction force, and has durability.

### TECHNICAL FIELD

The present invention relates to an electric impact tightening tool.

### BACKGROUND ART

In a conventional electric impact tightening tool, as disclosed, for example, in Japanese Patent Laid-Open No. 5-123975, the rotation of an output shaft of an inner-rotor electric motor is usually transmitted to an impact generation section via a reducer and an impact force generated in the impact generation section causes a strong torque on a main shaft.

However, the above-described conventional electric impact tightening tool has problems as described below.

### (Problem 1)

In an inner-rotor electric motor, as shown in FIG. 20, torque is transmitted from a magnet g to a rotor r and then a thin and brittle output shaft s which is press fitted into the rotor, and further to an impact generation section through a socket k provided at a forward end of the output shaft s.

The rotation speed of the impact generation section decreases at a stroke due to generation of a high torque as resistance to tightening from seating of a bolt or the like increases. Each time a high torque is generated, therefore, such decrease causes a large torsional force to act on the output shaft of the electric motor which would rotate at a constant speed.

As a result, the output shaft s and the rotor r or the press-fitted part of the socket k failed to slide on each other properly and resulting in failure of the transmission of the force. In case of a brush type motor, the proper positional relation between a commutator and a rotor is lost, and this electric motor ceases to work properly in a short time or does not work any more.

To solve the above-described problem, the output shaft s needs to be thicker. In this case, however, an electric motor to be used must be larger by one size or two sizes.

### (Problem 2)

In case of a brushless inner-rotor electric motor, which is small-sized to be used in a wrench, the no-load rotation speed increases to the order of 40000 to 50000 rpm when high power is input and, therefore, the rotation speed is reduced mainly by increasing the number of magnetic poles so as to increase torque.

In reducing the rotation speed by the above method, taking the size and weight of the electric motor into consideration, the number of magnetic poles could be increased double or so at the most, and such increase in number reduces the rotation speed to ½ or so. Therefore, a relatively large speed reducer becomes necessary and consequently the electric impact tightening tool increases in weight by the weight of the speed reducer.

### (Problem 3)

An electric impact tightening tool using an inner-rotor electric motor usually includes a speed reducer (a planetary gear mechanism) and, therefore, the power output is increased by the speed being reduced. Being received by an inner gear, the power is transmitted to an outer case. Therefore, a worker receives the power transmitted to the case and feels it as a relatively large reaction force, which results in deteriorating workability and increasing the degree of the worker's fatigue, and then the worker cannot work using the electric tightening tool for long hours.

Thus, the industries using and handling electric impact tightening tools have been awaiting development of an electric impact tightening tool that is small in size and light in weight, produces a low reaction force, and has durability.

### SUMMARY OF THE INVENTION

It is therefore an object of the present invention to provide an electric impact tightening tool that is small in size and light in weight, has a low reaction force and durability.

In an electric impact tightening tool according to the present invention, the rotation of an output section of an electric motor is transmitted to an impact generation section and an impact force generated in the impact generation section causes a strong torque on a main shaft and the foregoing electric motor is an outer-rotor electric motor. This outer-rotor electric motor may have low-speed, high-torque characteristics. The impact generation section may rotate simultaneously with a rotor flange portion at a forward end of the outer-rotor electric motor together as if they were one body.

The electric impact tightening tool according to the present invention can be small in size and in weight, and has a low reaction force and durability.

### BRIEF DESCRIPTION OF THE DRAWINGS

FIG. 1 is a sectional view of main portions of an electric impact tightening tool (an electric impulse wrench) in Embodiment 1 of the present invention.

FIG. 2 is a transverse sectional view of an outer-rotor electric motor incorporated in the foregoing electric impulse wrench.

FIG. 3 is a longitudinal sectional view of the outer-rotor electric motor incorporated in the foregoing electric impulse wrench.

FIG. 4 is a diagram to explain the principle of working of the above outer-rotor electric motor.

FIG. 5 is a diagram to explain the principle of working of the above outer-rotor electric motor.

FIG. 6 is a diagram to explain the principle of working of the above outer-rotor electric motor.

FIG. 7 is a diagram to explain the principle of working of the above outer-rotor electric motor.

FIG. 8 is a diagram to explain the principle of working of the above outer-rotor electric motor.

FIG. 9 is a sectional view of a hydraulic pulse generation section.

FIG. 10 is a series of sectional views of the hydraulic pulse generation section of the above electric impact wrench in use, taken along line A-A of FIG. 9, which includes a first to a fifth stage in one revolution.

FIG. 11 is an enlarged sectional view of the first stage in the above hydraulic pulse generation section.

FIG. 12 is an enlarged sectional view of the second stage in the above hydraulic pulse generation section.

FIG. 13 is a perspective view of a main shaft.

FIG. 14 is another perspective view of the main shaft.

FIG. 15 is an explanatory diagram of a rotor of an outer-rotor electric motor in another example.

FIG. 16 is an explanatory diagram of a rotor of an outer-rotor electric motor in another example.

FIG. 17 is a sectional view of an electric impact tightening tool (an electric wrench having a hammer type impact mechanism section) in Embodiment 2 of the present invention.

FIG. 18 is a sectional view of an electric impact tightening tool (an electric wrench having a clutch type impact mechanism section) in Embodiment 3 of the present invention.

FIG. 19 is a conceptual diagram of an electric wrench in a referential example.

FIG. 20 is a transverse sectional view of an inner-rotor electric motor.

FIG. 21 is a longitudinal sectional view of the inner-rotor electric motor.

FIG. 22 is a longitudinal sectional view of an outer-rotor electric motor.

FIG. 23 is an explanatory diagram of an outer-rotor electric motor in another example.

### DETAILED DESCRIPTION OF THE PREFERRED EMBODIMENT

Preferred Embodiments for carrying out an electric impact tightening tool of the present invention will be described below with reference to the drawings.

### Embodiment 1

Embodiment 1 relates to an electric impulse wrench R, one kind of the electric impact tightening tool of the present invention.

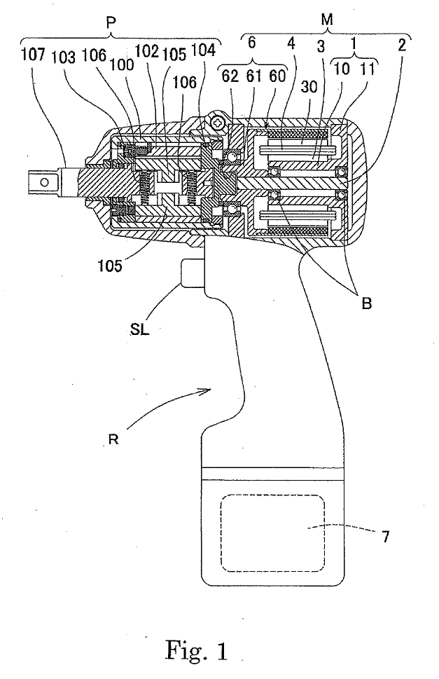

This electric impulse wrench R directly transmits the rotation of a rotor 6, which is an output section of an outer-rotor electric motor M, as shown in FIG. 1, to a liner 102 of a hydraulic pulse generation section P (corresponding to the impact generation section described in the section of Summary of the Invention), and, by an impact pulse generated in the hydraulic pulse generation section P, generates a strong torque on a main shaft 107. And the outer-rotor electric motor M is driven to rotate with a battery power supply 7.

As shown in FIGS. 1 to 3, the outer-rotor electric motor M includes a support 1, a rotary shaft 2, stators 3, coils 4, magnets 5 and a rotor: the support 1 has a cylindrical portion 10 and a flanged portion 11 provided on a side of one end of the cylindrical portion; the rotary shaft 2 is provided via inner races of a pair of bearings B provided within the cylindrical portion 10; the stators 3 are fixed to an outer circumferential surface of the cylindrical portion 10 and have six magnetic pole portions 30; the coils 4 are wound around the stators 3; the magnets 5 are attached to an inner surface side of a barrel portion 60 having a gap from an outer circumferential side of the stators 3; and the rotor 6 has the barrel portion 60 holding the magnets 5 on its inner circumferential surface, a rotor flange portion 61 tightly fitted onto the rotary shaft 2 and a socket portion 62 provided on the rotor flange portion 61. As shown in FIG. 1, this outer-rotor electric motor M is installed within the main wrench body by means of the support 1 fixed thereto with a screw and the like, not illustrated, so as not to drop.

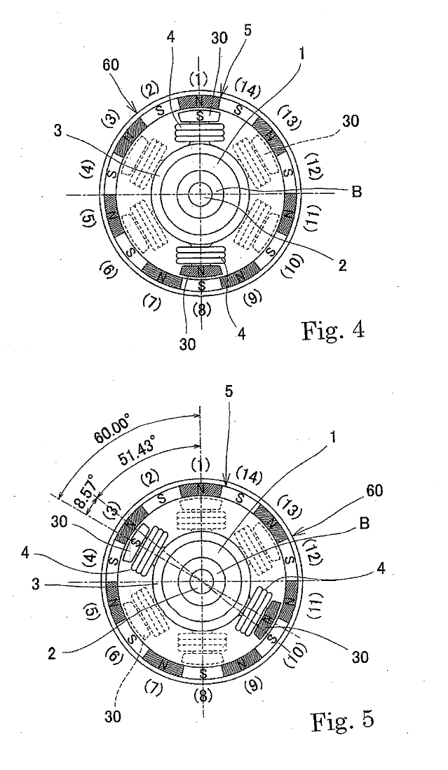

In this outer-rotor electric motor M, the rotor 6 is driven to rotate on the principle as shown in FIGS. 4 to 8. Coils 4 around stators 3 excite an S pole and an N pole in two poles (two teeth) (only the excited poles are indicated by solid lines), and an N pole and an S pole of the rotor 6 are attracted to the coils 4 of the stators 3. Magnetic pole pairs of the rotor 6 are arranged every angle of 360°/7=51.43°, and poles of the stators 3 are arranged every angle of 360°/6=60°.

(A) The excited positions of the coils 4 around the stators 3 shift by an angle of 60° (a change from a posture in FIG. 4 to a posture in FIG. 5).

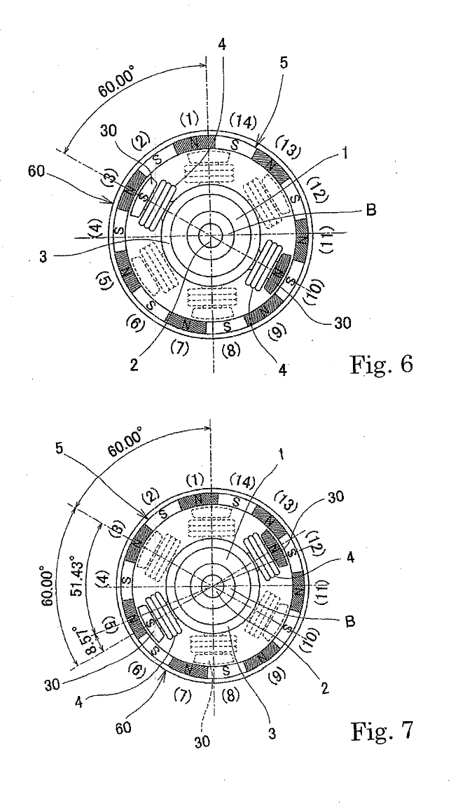

(B) When the excited positions shift or rotate by an angle of 60° as stated above, a magnet 5 of the rotor 6 are attracted in response to this rotation. More specifically, a magnet (3) out of the magnets 5 of the rotor 6, which is closest to the magnetic pole portion 30 of the excited stator 3, is attracted (a change from the posture of FIG. 5 to a posture of FIG. 6). In other words, while the magnetic poles of the coils 4 around the stators 3 make a 60° rotation, the rotor 6 rotates by an angle of 8.57° (360°/42) (calculating formula: 360°/6−360°/7=360°/42).

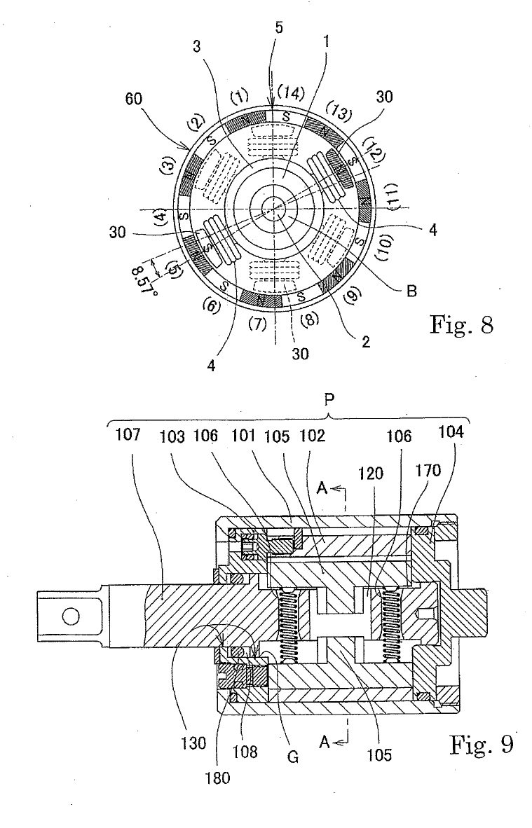

(C) The excited positions of the coils 4 around the stators 3 further rotate by an angle of 60° (a change from the posture in FIG. 6 to a posture in of FIG. 7). In response thereto, a magnet (5) out of the magnets 5 of the rotor 6 is attracted, and the rotor 6 rotates by an angle of 8.57° (360°/42) (a change from the posture in FIG. 7 to a posture in FIG. 8).

(D) The rotor 6 is caused to rotate by repeating the above (A) to (C). When the magnetic poles of the stators 3 revolve once (6×60°), the rotor 6 rotates by 360°/7. Under the same efficiency, a 7-fold torque is obtained.

In the hydraulic pulse generation section P, as shown in FIGS. 1 and 9, a liner 102 is provided within a liner case 101, and a main shaft 107 is fitted into the liner 102 so that the liner 102 is rotatable with respect to the main shaft 107. Working fluid (oil) for generating torque is filled in this liner 102, and the liner 102 is sealed with a liner bottom plate 103 and a liner top plate 104 attached to both ends of the liner 102.

As shown in FIG. 9, the liner bottom plate 103 has a hole 130 through which the main shaft 107 is inserted, and a chamber 108 formed between a constituting wall surface of the hole 130 and an outer circumferential surface of the main shaft 107 receives an O-ring 180 for ensuring air tightness (fluid tightness) therebetween.

The liner case 101 and the liner 102 are coupled together, and driven to rotate together as if they were one in response to the rotation of the outer-rotor electric motor M.

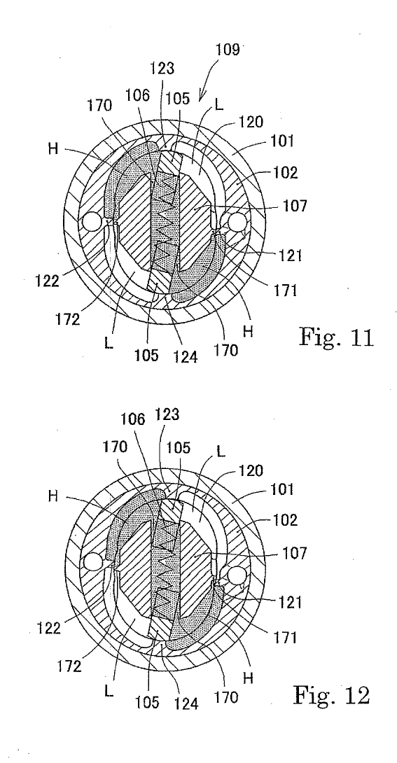

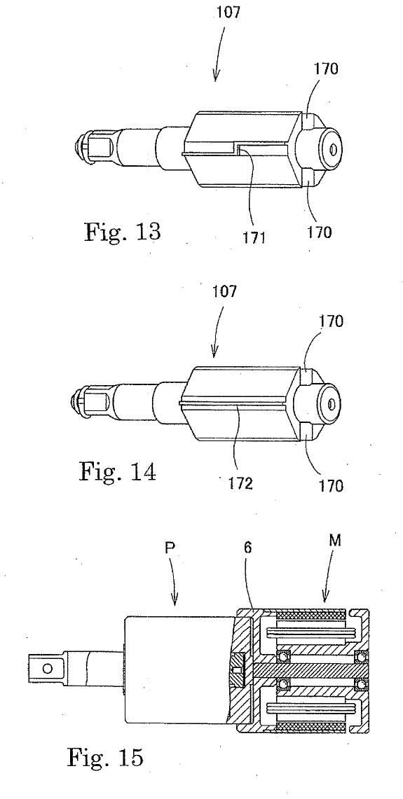

The interior of the liner 102 is shown in FIG. 11, and a liner chamber 120 having a cross section in the form of an ellipse is formed therein. Blades 105 are inserted in two opposing grooves 170 and 170 of the main shaft 107 via a spring 106, and contractibly abut against an inner surface of the liner 102 having a cross section in an elliptical form. As shown in FIGS. 13 and 14, the outer surface of the main shaft 107 is provided with second sealing faces 171 and 172 which are two protruding ribs positioned oppositely on the outer surface between the two blades 105 and 105. One of the second sealing faces 171 is formed in a stepped shape as shown in FIG. 13, while the other second sealing face 172 is linearly formed as shown in FIG. 14.

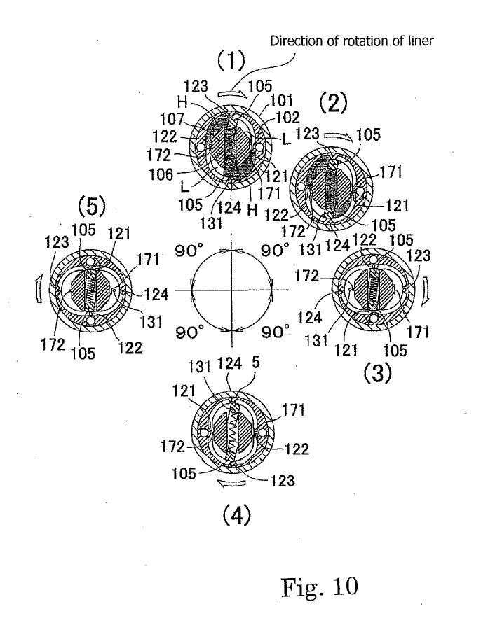

The inner circumferential surface of the liner 102, as shown in FIG. 11, is provided with first sealing faces 121, 122, 123 and 124 which are respectively projecting in a mound shape at both ends of the major axis of the elliptical section and on both sides of the minor axis thereof. And only once while the liner 102 is making one revolution with respect to the main shaft 107, as shown in (1) and (2) of FIG. 10, FIG. 11 and FIG. 12, the first sealing face 121 and the second sealing face 171, the first sealing face 122 and the second sealing face 172, the first sealing face 123 and an outer end surface of one of the blades 105, and the first sealing face 124 and an outer end surface of the other blade 105 respectively coincide with each other (they coincide so as to maintain an air-tightness in the whole area in the axial direction of the main shaft 107). As a result, the liner chamber 120 is hermetically divided into four chambers: two high-pressure chambers H and two low-pressure chambers L. To realize this, the first sealing face 121 is formed in the stepped shape in the same manner as the second sealing face 171, and the first sealing face 122 is formed linearly in the same manner as the second sealing face 172.

The above-mentioned hydraulic pulse generation section P is constituted as stated above, and a two-blade type impulse wrench R employing this hydraulic pulse generator P functions as follows.

Operation of a lever SL actuates the outer-roller electric motor M to rotate at a high speed and, in response thereto, the liner 102 also rotates.

In response to the rotation of the liner 102, the liner chamber 120 changes every 90° intervals as shown in (1)(2)-(3)-(4)-(5) of FIG. 10 while the liner 102 makes one revolution.

### Postures in (1) and (2) of FIG. 10

In the postures in (1) of FIG. 10 and in FIG. 11 showing an enlarged view thereof, the first sealing face 121 and the second sealing face 171, the first sealing face 122 and the second sealing face 172, the first sealing face 123 and an outer end surface of one of the blades 105, and the first sealing face 124 and an outer end surface of the other blade 105 respectively coincide with each other (they respectively coincide so as to maintain an air-tightness in the whole area in the axial direction of the main shaft 107). As a result, the liner chamber 120 is hermetically divided into four chambers: two high-pressure chambers H and two low-pressure chambers L.

And as shown in (2) of FIG. 10 and in FIG. 12 showing an enlarged view thereof, when the liner 102 rotates further responsive to the rotation of the outer-rotor electric motor M, the volume of each of the high-pressure chambers H decreases, the oil therein is compressed, and instantaneously a high pressure is generated. This high pressure forces the blades 105 toward the low-pressure chambers L. Couple of force acts instantaneously on the main shaft 107 via the upper and lower blades 105 and 105, which generates a strong torque.

### Posture in (3) of FIG. 10

(3) of FIG. 10 shows a posture in which the liner has made a 90° rotation after the generation of torque on the main shaft 107.

In the liner chamber 120, each of the high-pressure chambers H and each of the low-pressure chambers L communicate with each other and form respective unified chambers having the upper and lower blades 105 and 105 therebetween. Here no torque is generated and the liner 102 further rotates in response to the rotation of the outer-rotor electric motor M.

### Posture in (4) of FIG. 10

(4) of FIG. 10 shows another posture in which the liner has made a further 90° rotation from the posture in (3) of FIG. 10, namely a 180° rotation from an impacting blow.

The first sealing face 121 and the second sealing face 172 do not coincide with each other, while the first sealing face 122 and the second sealing face 171 do coincide with each other only with a tiny portion. Therefore between the sealing faces exists no sealing, pressure doesn't change and torque is not generated. The liner 2 continues to rotate.

### Posture in (5) of FIG. 10

(5) of FIG. 10 shows another posture in which the liner has made a further 90° rotation from the posture in (4) of FIG. 10, namely a 270° rotation from the impacting blow.

This posture is substantially the same as that in (3) of FIG. 10 and no torque is generated. With a further rotation, the liner returns to the posture in (1) of FIG. 10, and then the first sealing face 121 and the second sealing face 171, the first sealing face 122 and the second sealing face 172, the first sealing face 123 and the outer end surface of one of the blades 105, and the first sealing face 124 and the outer end surface of the other blade 105 respectively coincide with each other, which generate another impacting blow force.

As stated above, one impacting blow force is generated per revolution of the liner 102.

The manner of coupling between the outer-rotor electric motor M and the hydraulic pulse generation section P is shown in FIG. 1. A hexagonal part of the liner top plate 104 of the hydraulic pulse generation section P is inserted into the socket portion 62 of the outer-rotor electric motor M so that rotation is transmitted.

This electric impulse wrench R has the following advantageous features.

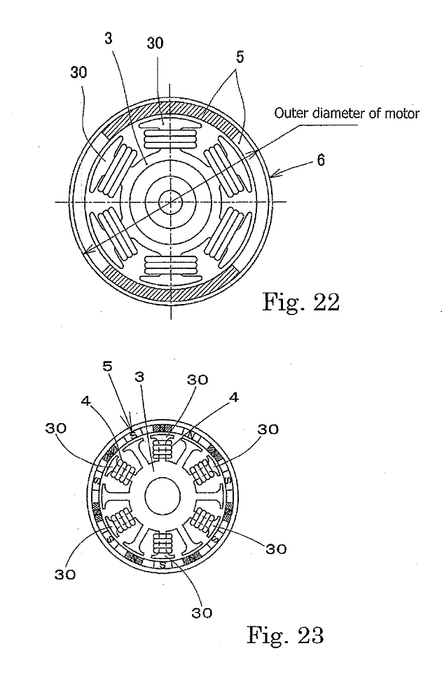

(1) In an inner-rotor electric motor, as shown in FIG. 21, the diameter of a rotor 6′ is about ⅔ of the outside diameter of a motor, whereas in an outer-rotor electric motor, as shown in FIG. 22, the diameter of a rotor 6 per se is the outside diameter of a motor. Therefore, when driven with the same magnetic force, the output torque of the outer-rotor electric motor becomes about 1.5 times as large as that of the inner-rotor motor. In other words, when the output torque is made the same in both the motors, the outside diameter of the outer-rotor electric motor becomes about ⅔ times smaller than that of the inner-rotor motor.

Therefore, with use of an outer-rotor electric motor as a driving source, an electric impulse wrench can be downsized and reduced in weight.

In one type of outer-rotor electric motor, as shown in FIG. 22, which has six poles of the magnetic pole portions 30 of the stators 3 and four poles of the magnets 5 on the rotor 6, the rotation speed of the rotor 6 is the same (40000 to 50000 rpm) as the speed of the rotating magnetic field in the stators 3. On the other hand, in the outer-rotor electric motor M of this embodiment which has six poles of the magnetic pole portions 30 of the stators 3 and 14 poles of the magnets 5 on the rotor 6, the rotation speed of the rotor 6 becomes 1/7 (6000 to 7000 rpm) of the speed of the rotating magnetic field in the stators 3. That is, the outer-rotor electric motor of this embodiment has not only high-torque characteristics but also low-speed characteristics.

Therefore, this electric impulse wrench R does not have to have a speed reducer, and thereby can be reduced in size and weight by those of such an reducer and a worker receives less reaction force therefrom.

From the viewpoint of the above two factors, compared with a conventional one, this electric impulse wrench R can be considerably downsized and reduced in weight.

(2) In this electric impulse wrench R, the rotation speed of the liner 102 of the hydraulic pulse generation section P decreases at a stroke likewise due to the generation of a high torque following an increase in resistance to tightening by seating of a bolt and the like.

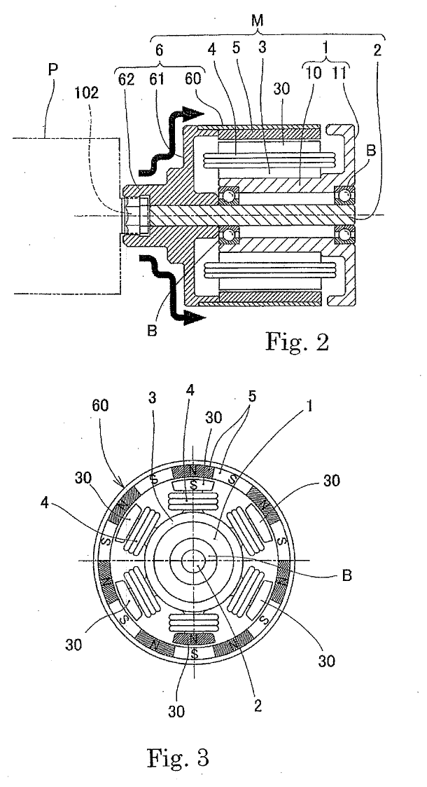

However, in this electric impulse wrench R, a torsional force from the liner 102 is transmitted not by a conventional thin output shaft that is brittle in terms of strength, but through a route indicated by the black arrows in FIG. 2 (the route from the socket portion 62→the rotor's flange portion 61→the barrel portion 60 in the rotor 6). Therefore, this electric impulse wrench R has very high resistance to the foregoing torsional force.

Consequently, different from the conventional electric impact tightening tool as observed above in the section of Prior Art, the situation that an electric motor ceases to work properly in a short time or does not work won't happen in this electric impact tightening tool. In other words, this electric impulse wrench R has an excellent durability.

(3) From the above, the constitution of this electric impulse wrench R allows the wrench R to be reduced in size and weight, and have a low reaction force and an excellent durability.

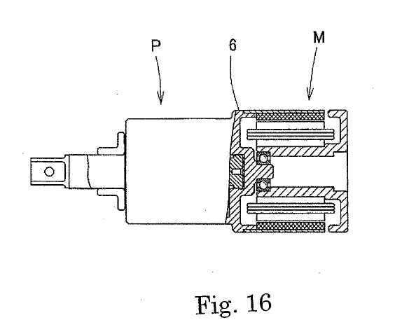

Other manners of coupling the outer-rotor electric motor M and the hydraulic pulse generation section P are shown in FIGS. 15 and 16, in which a motor has another type of rotors 6 in place of the outer-rotor electric motor M of the above embodiment. With the constitution of this electric impulse wrench R, in addition to being small in size and weight and with a low reaction force and an excellent durability, the electric impulse wrench R further provides the following advantageous features.

The constitution shown in FIG. 15 being adopted, a joint area is present on the outer circumference of the hydraulic pulse generation section P, and consequently the wrench is allowed to have a shorter whole length and the strength that is large enough to transmit force.

In the constitution in FIG. 16, the hydraulic pulse generation section P and the rotor 6 of the outer-rotor electric motor M are formed in one body. In this case, a joint area being unnecessary, the whole length of the wrench could be reduced.

The features and constitutions stated above hold true in Embodiments 2 and 3 described below.

### Embodiment 2

Embodiment 2 relates to an electric hammer wrench R1, one kind of the electric impact tightening tool of the present invention, having a hammer type impact mechanism 8 (corresponding to the impact generation section described in the section of Summary of the Invention).

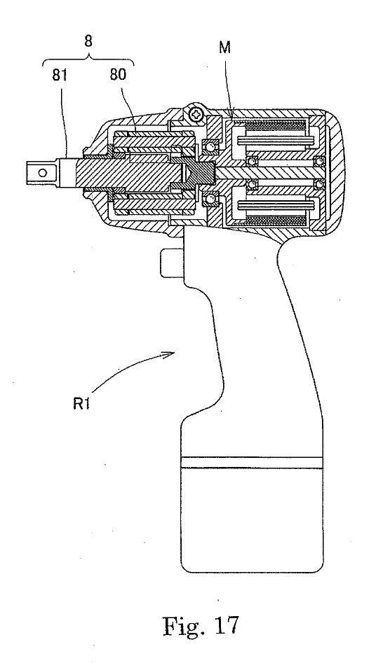

As shown in FIG. 17, this electric hammer wrench R1 has a hammer impact mechanism 8 including a hammer 80 and an anvil 81. When the hammer 80 rotates in response to the rotation of an outer-rotor electric motor M and gives an impacting blow to the anvil 81, an impact force is generated in the anvil 81. The impact force is transmitted to a bolt and the like as torque, and they are tightened. An impact force is generated once per revolution of the hammer 8.

This electric hammer wrench R1 also employs an outer-rotor electric motor M like in Embodiment 1 and, therefore, apparently advantageously functions likewise.

### Embodiment 3

Embodiment 3 relates to an electric clutch wrench R2, one kind of the electric impact tightening tool of the present invention, having a clutch type impact generation section 9 (corresponding to the impact generation section described in the section of Summary of the Invention).

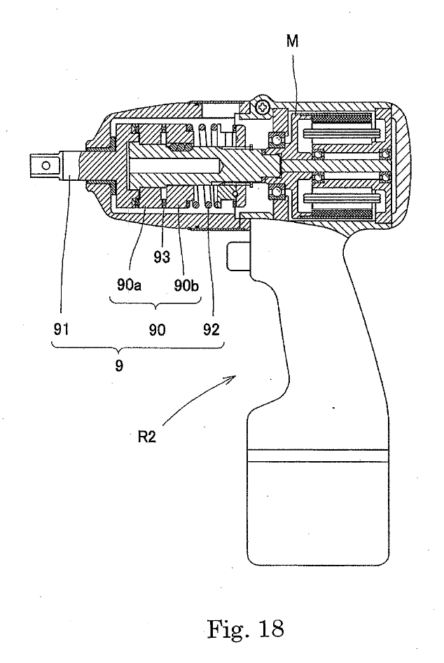

As shown in FIG. 18, this electric clutch wrench R2 has a clutch type impact generation section 9 provided with a clutch section 90 having a lower clutch 90a and an upper clutch 90b engaging therewith, a main shaft 91, and a coil spring 92 that forces to push the upper clutch 90b toward the lower clutch 90a. The rotational force of an outer-rotor electric motor M is transmitted to the main shaft 91 via the clutch section 90 as tightening torque.

In the clutch type impact generation section 9 in this electric clutch wrench R2, engaging part 93 between the lower clutch 90a and the upper clutch 90b is in the manner that respective tapered clutches engage each other. When a bolt and the like are tightened with not less than a specific torque, the force of the lower clutch 90a that is going to stop becomes larger than the engaging force of the engaging part 93 and consequently the upper clutch 90b disengages from the lower clutch 90a (the upper clutch 90b climbs over tapered part of the lower clutch 90a). After that, the upper clutch 90b again engages with the lower clutch 90a. These engagement and disengagement are repeated and an impact force is generated each time when the upper clutch 90b disengages from the lower clutch 90a (see FIG. 18).

This electric hammer wrench R2 also employs an outer-rotor electric motor M like in Embodiment 1 and, therefore, apparently advantageously functions likewise.

The electric impact tightening tools in Embodiments 1 to 3 stated above are some examples. As long as electric impact tightening tools are constituted in the manner that the rotation of an output section of an outer-rotor electric motor is transmitted to an impact generation section and an impact force generated in this impact generation section causes a strong torque on the main shaft, such tools fall in the technical scope of the present invention.

In the above-described embodiments, six magnetic pole portions 30 are provided in the stator part 3. Another possible example is to provide 12 portions to be able to be magnetic pole portions 30 on the stator part 3 and wind a coil 4 around every other portions.

Furthermore, the number of magnetic pole portions 30 formed on the stator part 3 is not limitative to six, but changeable as required.

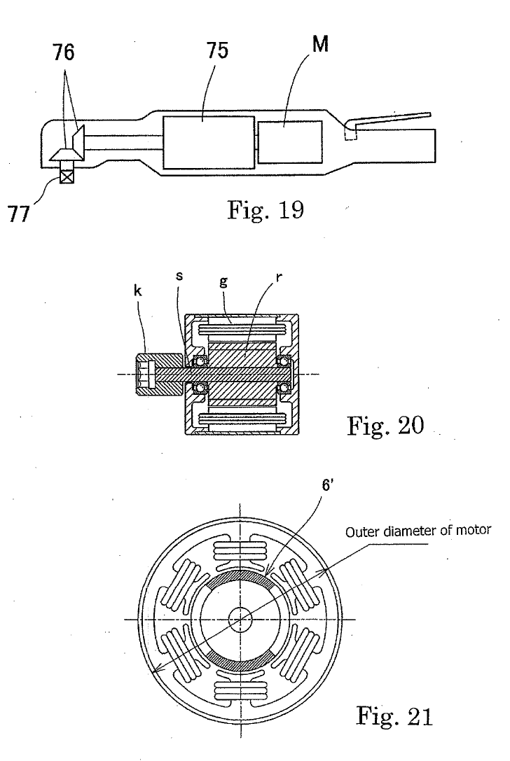

The outer-rotor electric motor M can be used in an electric wrench of the type shown in FIG. 19. In this electric wrench, the rotation of the outer-rotor electric motor M is transmitted through a two-stage or three-stage planetary gear 75→a pair of bevel gears 76→an output shaft 77 and tightens a screw and the like. In this electric wrench, the outer-rotor electric motor M allows to reduce the number of stages of the planetary gear as stated above and consequently to reduce the weight of the whole wrench.

1. An electric impact tightening tool comprising an electric motor, an output section thereof, an impact generation section, and a main shaft, wherein rotation of the output section of the electric motor is transmitted to the impact generation section and an impact force generated in the impact generation section causes a strong torque to the main shaft and the electric motor is an outer-rotor electric motor.

2. The electric impact tightening tool according claim 1, wherein the outer-rotor electric motor has low-speed and high-torque characteristics.

3. The electric impact tightening tool according to claim 1, wherein the impact generation section and a rotor flange provided at a forward end of the outer-rotor electric motor rotate together simultaneously as if they were one body.

4. The electric impact tightening tool according to claim 2, wherein the impact generation section and a rotor flange provided at a forward end of the outer-rotor electric motor rotate together simultaneously as if they were one body.
